(19) United States
(12) Patent Application Publication
(10) Pub. No.: US 2010/0070239 A1
(43) Pub. Date: Mar. 18, 2010

(54) PERFORMANCE EVALUATION DEVICE AND PERFORMANCE EVALUATION METHOD

(76) Inventor: Tsung-Pin WANG, Taipei City (TW)

Correspondence Address: BRIAN M. MCINNIS, 12th Floor, Ruttonjee House, 11 Duddell Street, Hong Kong, HK

(21) Appl. No.: 12/335,154

(22) Filed: Dec. 15, 2008

(30) Foreign Application Priority Data
Sep. 18, 2008 (TW) 97135857

(51) Int. Cl. G06F 15/00

(52) U.S. Cl. 702/182

(57) ABSTRACT

A performance evaluation device and a performance evaluation method to evaluate at least one under-test module in a ROM of an electronic device are provided. The performance evaluation device comprises a time stamp counter, a measuring module, a recording module and a calculating module. The time stamp counter increments every time period to generate a time-stamp-number. The measuring module measures a unit-time time-stamp-number during a unit time to further calculates the time period. The recording module records a begin time-stamp-number when the at least one under-test module begins the operation and a finish time-stamp-number when the at least one under-test module finishes the operation. And the calculating module calculates an operation time data according to a difference between the begin time-stamp-number and the finish time-stamp-number and the time period.

### RELATED APPLICATIONS

This application claims priority to Taiwan Application Serial Number 97135857, filed Sep. 18, 2008, which is herein incorporated by reference.

### BACKGROUND

1. Field of Invention

The present invention relates to a performance evaluation device. More particularly, the present invention relates to a performance evaluation device and a performance evaluation method.

2. Description of Related Art

When a computer begins to operate, the BIOS reads the option ROM to get the information of different devices connected to the computer. Option Rom comprises various kinds of firmware each corresponding to a device. Each firmware further comprises different function modules having different performance. Some function modules take shorter time to perform their functions, and some other may take lots of time to finish operation. A conventional solution is to re-design the whole option ROM, which is time-consuming. Thus, if there is a mechanism to evaluate the performance of each function modules in the option ROM to distinguish the function modules that affect the overall performance most, then it's not necessary to spend time on re-designing the whole option ROM.

Accordingly, what is needed is a performance evaluation device and a performance evaluation method to evaluate each function module in the option ROM to overcome the above problems. The present invention addresses such a need.

### SUMMARY

A performance evaluation device to evaluate at least one under-test module in a ROM of an electronic device is provided. The performance evaluation device comprises a time stamp counter, a measuring module, a recording module and a calculating module. The time stamp counter increments every time period to generate a time-stamp-number. The measuring module measures a unit-time time-stamp-number during a unit time to further calculates the time period. The recording module records a begin time-stamp-number when the at least one under-test module begins the operation and a finish time-stamp-number when the at least one under-test module finishes the operation. And the calculating module calculates an operation time data according to a difference between the begin time-stamp-number and the finish time-stamp-number and the time period.

Another object of the present invention is to provide a performance evaluation method to evaluate at least one under-test module in a ROM of an electronic device. The performance evaluation method comprises the steps of: measuring a unit-time time-stamp-number during a unit time to further calculates the time period; recording a begin time-stamp-number when the at least one under-test module begins the operation and a finish time-stamp-number when the at least one under-test module finishes the operation; and calculating an operation time data according to a difference between the begin time-stamp-number and the finish time-stamp-number and the time period.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of an electronic device of the first embodiment of the present invention;

FIG. 2 is a block diagram of the performance evaluation device of the first embodiment of the present invention; and

FIG. 3 is a flow chart of the performance evaluation method of the second embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

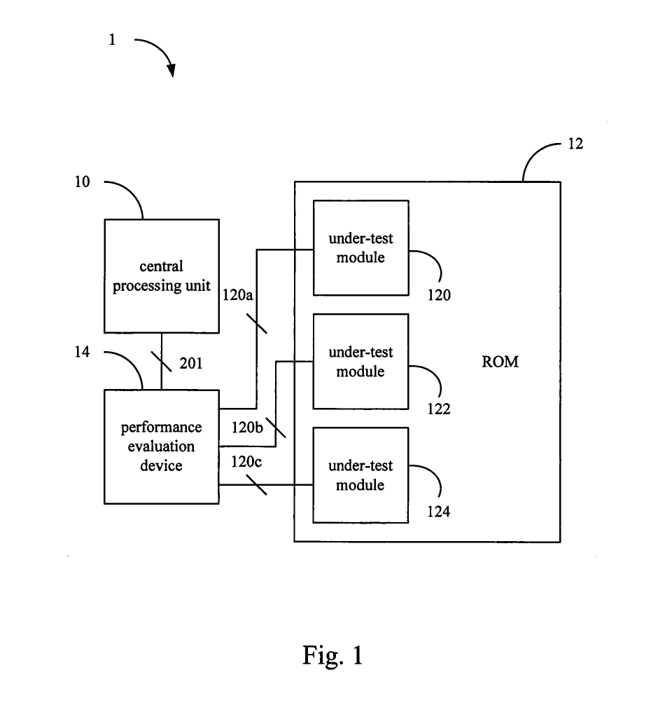

Please refer to FIG. 1, a block diagram of an electronic device 1 of the first embodiment of the present invention. The electronic device 1 comprises a central processing unit 10, an ROM 12 and a performance evaluation device 14. The performance evaluation device 14 is used to evaluate three under-test modules 120, 122 and 124 in the ROM 12 of the electronic device 1. The ROM 12 is substantially an option ROM 12, and the under-test modules 120, 122 and 124 are the firmware modules in the option ROM 12. Though these firmware function modules, the electronic device 1 can connect and control other hardware devices (not shown) adapted in the electronic device 1. In other embodiment, the number of the under-test modules can vary according to different situations.

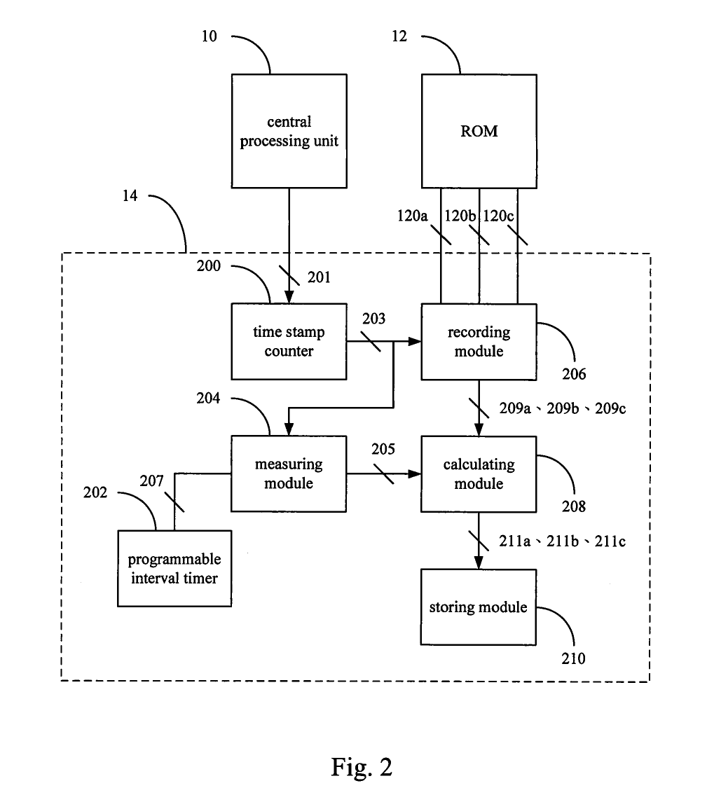

Please refer to FIG. 2, a block diagram of the performance evaluation device 14 of the first embodiment of the present invention. The performance evaluation device 14 comprises a time stamp counter 200, a programmable interval timer 202, a measuring module 204, a recording module 206, a calculating module 208 and a storing module 210. The time stamp counter 200 increments every time period 201 to generate a time-stamp-number 203. The time period 201 substantially refers to the oscillation frequency of the central processing unit 10, wherein the time period 201 is the reciprocal of the oscillation frequency. Different electronic devices have different central processing units, therefore the oscillation frequency varies in different electronic devices. Thus, the time period 201 will be calculated through the measurement of a unit-time time-stamp-number 205. The programmable interval timer 202 can generate an accurate fixed delay time interval, such as 1 ms. Thus, the unit time 207 of the measuring module 204 is defined by the programmable interval timer 202. After defining the unit time 207, the measuring module 204 measures the amount of the variation of the time-stamp-number 203 to further calculate the unit-time time-stamp-number 205. The unit-time time-stamp-number 205 is substantially the oscillation frequency of the central processing unit 10. Therefore, the time period 201, which is the reciprocal of the oscillation frequency, can be found.

When each under-test modules 120, 122 and 124 begins or finishes the operation, a operation signal 120a, 122a and 124a will be generated and sent to the recording module 206. Thus, the recording module 206 records three begin time-stamp-numbers each corresponding to a under-test module when the under-test modules 120, 122 and 124 begin the operation, and three finish time-stamp-numbers when the under-test modules 120, 122 and 124 finish the operation. And the calculating module 208 further calculates an operation time data 211a, 211b and 211c according to a difference 209a, 209b and 209c between the begin time-stamp-number and the finish time-stamp-number of each under-test module 120, 122 and 124 and the time period 201. For instance, if the difference is a, the unit-time time-stamp-number is b, the operation time is c, then c=a/b. According to these operation time data 211a, 211b and 211c, the duration of the operation of these under-test modules 120, 122 and 124 can be calculated, and the performance of these under-test modules 120, 122 and 124 can be evaluated as well. Therefore, only the modules taking longer time to finish operation need to re-design. In the present embodiment, the performance evaluation device 14 operates before the operation system of the electronic device 1 starts to manage the electronic device 1. Thus, the operation time data 211a, 211b and 211c are stored in the storing module 210 first. After the operation system controls the electronic device 1, the user can read these operation time data 211a, 211b and 211c shown on a screen (not shown) of the electronic device 1.

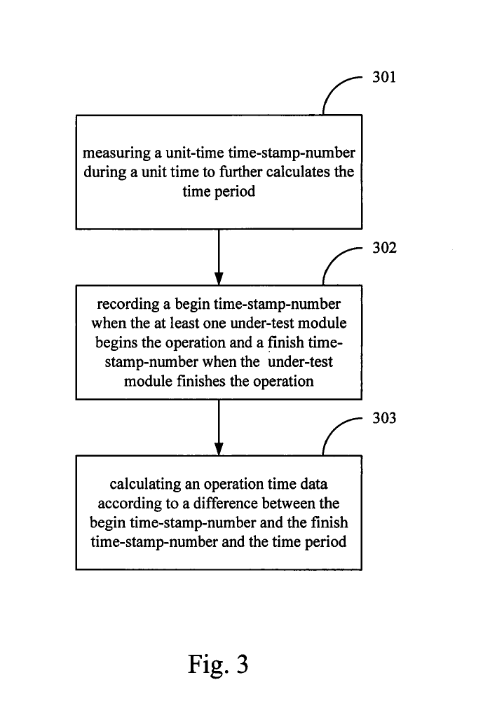

The second embodiment of the present invention is a performance evaluation method to evaluate at least one under-test module in a ROM of an electronic device. As depicted in FIG. 3, a flow chart of the performance evaluation method of the second embodiment of the present invention, the performance evaluation method comprises the steps of: at step 301, measuring a unit-time time-stamp-number during a unit time to further calculates the time period; at step 302, recording a begin time-stamp-number when the at least one under-test module begins the operation and a finish time-stamp-number when the at least one under-test module finishes the operation; and at step 303, calculating an operation time data according to a difference between the begin time-stamp-number and the finish time-stamp-number and the time period.

The present invention provides a performance evaluation device and a performance evaluation method to evaluate the performance of each under-test module in the option ROM in an electronic device. Thus, the function modules that affect the overall performance most can be detected, and a re-design of the whole option ROM, which is time-consuming, can be avoided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A performance evaluation device to evaluate at least one under-test module in a ROM of an electronic device, the performance evaluation device comprises:
a time stamp counter (TSC) to increment every time period to generate a time-stamp-number,
a measuring module to measure a unit-time time-stamp-number during a unit time to further calculates the time period;
a recording module to record a begin time-stamp-number when the at least one under-test module begins the operation and a finish time-stamp-number when the at least one under-test module finishes the operation; and
a calculating module to calculate an operation time data according to a difference between the begin time-stamp-number and the finish time-stamp-number and the time period.

2. The performance evaluation device of claim 1, wherein the electronic device further comprises a central processing unit having an oscillation frequency, wherein the oscillation frequency corresponds to the time period.

3. The performance evaluation device of claim 1, further comprising a programmable interval timer, wherein the unit time is defined by the programmable interval timer.

4. The performance evaluation device of claim 1, wherein the ROM is an option ROM.

5. The performance evaluation device of claim 1, wherein the at least one under-test module is a firmware function module.

6. The performance evaluation device of claim 1, further comprising a storing module to store the operation time data of the at least one under-test module.

7. A performance evaluation method to evaluate at least one under-test module in a ROM of an electronic device, the performance evaluation method comprises the steps of:
measuring a unit-time time-stamp-number during a unit time to further calculates the time period;
recording a begin time-stamp-number when the at least one under-test module begins the operation and a finish time-stamp-number when the at least one under-test module finishes the operation; and
calculating an operation time data according to a difference between the begin time-stamp-number and the finish time-stamp-number and the time period.

8. The performance evaluation method of claim 7, wherein the electronic device further comprises a central processing unit having an oscillation frequency, wherein the oscillation frequency corresponds to the time period.

9. The performance evaluation device of claim 7, wherein the unit time is defined by a programmable interval timer.

10. The performance evaluation device of claim 7, wherein the ROM is an option ROM.

11. The performance evaluation device of claim 7, wherein the at least one under-test module is a firmware function module.

12. The performance evaluation device of claim 7, after calculating the operation time data further comprising a step of storing the operation time data of the at least one under-test module.
